(19) United States
(12) Patent Application Publication
(10) Pub. No.: US 2016/0104337 A1
(43) Pub. Date: Apr. 14, 2016

(54) Detection System for Optical Codes

(71) Applicant: SICK AG, Waldkirch/Breisgau (DE)

(72) Inventors: Pascal SCHULER, Teningen (DE); Sascha BURGHARDT, Waldkirch (DE)

(21) Appl. No.: 14/873,516

(22) Filed: Oct. 2, 2015

(30) Foreign Application Priority Data
Oct. 14, 2014 (EP) 14 188 805.7

(51) Int. Cl. G07D 7/12; G06K 7/14

(52) U.S. Cl. CPC G07D 7/124; G06K 7/1447

(57) ABSTRACT

A detection system for optical codes that are applied to an object that is conveyed through a reading field of a sensor of the detection system, wherein the detection system is configured to record a sequence of images from a respective part of the object which is present in the reading field at the respective time of recording of a respective image by means of the sensor, is characterized in that the detection system is further configured to determine a respective displacement vector between two respective consecutive images of the image sequence by means of the two respective consecutive images, wherein the respective displacement vector reflects how far an image region included in an image is displaced relative to a previous image, and with the image region also being present in the previous image.

The present invention relates to a detection system for optical codes that are applied to an object that is conveyed through a reading field of a sensor of the detection system, wherein the detection system is configured to record a sequence of images of a respective part of the object that is present at the respective recording time of a respective image in the reading field by means of the sensor.

Using such a detection system known from the state of the art, a code present on the object can thus be followed, this means tracked. It is disadvantageous in the detection system known from the state of the art for the tracking of the code that at least one further sensor is required, with the further sensor determining the conveying speed of the object through the reading field and moreover that the alignment of the sensor with respect to the conveying direction of the object has to be pre-defined.

The DE 100 51 415 C2 describes an optical tracking system by means of which a position determination and/or orientation determination of an object equipped with a marker can be carried out by means of the use of at least two image recorders.

The present invention is based on the object of providing an improved detection system in which codes detected in the images can be followed, this means tracked across the sequence of images in a simple and efficient manner.

The object is satisfied by a detection system having the features of claim 1 and in particular thereby that a detection system of the initially named kind is configured to determine a respective displacement vector between two respective consecutive images of the image sequence, by means of the two respective consecutive images, wherein the respective displacement vector reflects how an image region contained in an image is displaced relative to a previous image, with the image region also being present in the previous image.

By means of the displacement vectors determined between the consecutive images it is possible to determine the respective position of a code detected once across the sequence of images by way of calculation and in this manner to follow the position of the code, at least by way of calculation, across the sequence of images and thus to track the code—in particular without the use of a further sensor—across the recorded image sequence.

A code is, for example, detected for the first time in a first image of the image sequence and is possibly decoded. In this respect its position can be determined in the first image. With reference to the known position of the code in the first image and the displacement vector the fictitious position of the code in the second image can be calculated, this is because the displacement vector is determined between a second image consecutive to the first image and the first image in accordance with the invention. In this respect the position of the code in the second image is referred to as a fictitious position or as a virtual position, as the position of the code in the second image is not determined from the second image, but is only calculated. Naturally it can be provided that the actual position of the code in the second image is also detected by means of the sensor, in particular for the verification of the calculated fictitious position. By means of the displacement vector that is determined between a third image consecutive to the second image and the second image, the fictitious position of a code can then in turn be calculated with respect to the third image. This can be continued up until the last image such that the code can be tracked across the consecutive images of the image sequence up to the last image on use of the displacement vectors.

In this sense, in accordance with an embodiment of the invention, the detection system is configured to determine a fictitious position of the code with reference to the consecutive image by means of the position of the code detected in the image and by means of the displacement vector determined between the image and its consecutive image. The calculated, virtual position or fictitious position of the code can thus be predicted in the consecutive image without the actual position of the code being determined in a consecutive image.

In this connection it can also occur that the code cannot be seen in all subsequent images after its detection in one of the images, as the code leaves the reading field in dependence on the conveying speed at some point in time. Virtually, this means fictitiously and/or purely by way of calculation, the code can, however, be followed up to the point in time of the recording of the last image, in that, for example, it is permitted that the coordinates, that describe the fictitious position of the code with reference to a coordinate system defined for each image, can also lie outside of the image boundary.

Preferably, the detection system is configured to determine for at least one and preferably for all of the codes detected in the image sequence, a respective fictitious position at least with respect to the last image of the image sequence, by means of the displacement vectors. The relative position and/or arrangement of the codes with respect to one another can thus be determined by means of their fictitious position and with reference to the last image of the image sequence. Thereby, for example, a virtual stitched image of the object can be generated in which the detected codes are reproduced corresponding to their relative position.

In accordance with an embodiment of the invention, the detection system is configured to sort the detected codes in dependence on their respective fictitious position with respect to the last image of the image sequence. The codes can thus be sorted in accordance with their fictitious position and in this way can, for example, be listed, for example, in a list, that is also referred to as a tracking list in the following, in accordance with the respective fictitious position and can be output.

Preferably the detection system is configured to detect at least the position of the code in the image for a code included in an image. The position of the code can in this respect be determined in the form of X and Y coordinates in a coordinate system defined with respect to the image.

The position of the code can moreover be stored, in particular together with the code, in a list of the detected codes that is also referred to as a tracking list.

Preferably the detection system is configured to decode a code detected in an image. The code content and possibly further code features, such as the code type and the length of the code can thus be determined by the detection system.

The detection system can further be configured to store the code detected in an image, in particular data of the code obtained by decoding the code detected in an image, in particular together with the position of the code, preferably in the already mentioned tracking list.

The detection system can be configured for the purpose of updating the position of the code through the fictitious position, in particular for updating the position of the code stored in the tracking list. The tracking list can thus be updated with respect to the consecutive image and the respective position of the code detected in the tracking list.

In accordance with a further embodiment of the invention the detection system is configured to determine a further fictitious position of the code with respect to a second consecutive image by means of the fictitious position and by means of the displacement vector determined between the consecutive image and the next consecutive image, the second consecutive image and in a corresponding way to determine a respective further fictitious position of the code in the respective consecutive image for each further consecutive image up until the fictitious position of the code is determined with respect to the last image for the last image of the sequence of images.

In this respect the tracking list can be updated through the respectively newly determined fictitious position for the code in such a way that at the end, the tracking list includes the respective fictitious position of each code in relation to the last image of the recorded sequence of images for all detected codes. In this way the fictitious position of all detected codes can be drawn on from the tracking list in relation to the last image of the image sequence. All detected codes can in this way be followed across the image sequence up to the last image, in particular on use of the tracking list, this means they can be tracked. Thereby a stitched virtual image can be generated in which all codes are illustrated with respect to one another in accordance with their relative position and are not bound by the reading field of the sensor.

The detection system can be configured for the purpose of decoding a code that is detected at a calculated fictitious position in a respective consecutive image or, in particular if the code has already been successfully decoded, to no longer decode it.

The code detected at the fictitious position in the consecutive image is normally the same code like the already detected code. In this way a repeated decoding of this code can be dispensed with when the code has already been successfully decoded in a previous image. Calculation time can thereby be saved.

The sensor can work in such a way that it initially carries out a segmentation of a recorded image and subsequently decodes a code detected in a region of the image on the segmentation. As the fictitious position of an already detected and decoded code can be predicted for a consecutive image it is possible to in this way determine the region with respect to the segmentation in which the code is located in the consecutive image. In this way, one can dispense with the repeated decoding of the code present in this region in order to save calculation time. Moreover, the region can already be exempted from the segmentation, in particular can be masked out, whereby further calculation time is saved.

The detection system can be configured for the purpose of identifying pairs of codes by means of at least one displacement vector, wherein a respective code pair is formed from a first code and the same second code detected in a later image. In this way codes detected in different images can be recognized as the same codes and can be consolidated to a code pair.

Preferably the detection system is configured for the purpose of comparing the position of a second code in a later image with the fictitious position of a first code calculated for the later image and to identify the first code and the second code as a code pair when the position and the fictitious position are at least substantially in agreement.

The first code can be stored together with the fictitious position in the tracking list. In that the second code and the first code are identified as code pairs it can be prevented that the second code is detected separate from the first code in the tracking list and in this way are not tracked as a further code by means of the tracking list across the sequence of images.

The detection system can be configured to update and/or supplement and/or verify data of the first code obtained by means of decoding with and/or by data of the second code obtained by means of decoding. In particular the data of the first and second codes obtained by means of decoding can be calculated with respect to one another in dependence on a respectively achieved result class. This will be described in the following in the framework of the description of Figures.

By means of the “calculation” of like codes, but of codes detected in different images, for example statistical data, in particular with reference to a reading rate statistic can be improved by masking out e.g. non-readable codes.

In accordance with an embodiment of the invention the detection system is configured for the purpose of determining a conveying speed with which the object is conveyed through the reading field by means of at least one displacement vector. The displacement vector reflects the displacement of an image region contained in an image relative to its position in the previous image, for example in the form of pixels. If the relation of the pixels in millimetres with reference to the conveying path and the frame rate of the image recording are known then the conveying speed of the object and indeed respectively from image to image can be determined. Thereby, for example, statistics on the speed behaviour of a conveyor belt used for the conveying of the object can be generated. Moreover the conveying speed can be visualized with respect to the reading gate. Furthermore, a conveyor band stand still can be detected and a corresponding message can be output, e.g. in order to avoid a polling of reading results during a band stand still.

It is particularly advantageous if the detection system is configured for the purpose of calculating a respective displacement vector between an image and its consecutive image on use of a correlative method in which at least one profile obtained from the image is correlated with a profile obtained from the consecutive image. Thereby a respective displacement vector can be determined in a reliable manner and in a comparatively short period of time. Moreover, the correlative method can be configured in such a way that it can be carried out independent of the presence of a code in the image or in the consecutive image. Thus, a respective displacement vector between an image and its consecutive image can always be determined even when no code is included in the images.

The previously made explanations relate to optical codes. The detection system in accordance with the invention is, however, also suitable for the purpose of detecting different optically detectable elements and on use of the displacement vectors—preferably determined by means of the described correlative method—to follow and/or to track displacement vectors, across the recorded sequence of images as is described in the foregoing with reference to the optical codes. Having regard to the process of the tracking a different optically detectable element can be tracked across the image sequence by means of the detection system in accordance with the invention—in the same way like an optical code can be tracked. The explanations made in the foregoing with regard to the tracking are in this way not only true for optical codes, but also for different optically detectable elements.

Such an optically detectable element can, for example, be an edge or a vertex of the object passing through the reading field of the sensor in order to detect a marking on the object configured in any possible way, in order to detect a contour that is provided at the object or on the object or a different element on the object that can be detected by the detection system, for example, by a blob detection. Having regard to a blob detection, for example, the centroid of a segmented individual element can be detected in a recorded image and can be tracked by means of the detection system across the recorded image sequence.

The detection system can be configured for the purpose of identifying pairs of optical elements by means of at least one displacement vector also with regard to such optically detectable elements, wherein a respective element pair is formed from a first element and the like second element detected in a later image. Optical elements detected in different images can be recognized as the same elements and can be consolidated to an element pair. In this respect areal features or contour features present can, for example, be drawn on and compared with one another for verification that the element pair is actually composed of the same elements.

Preferred embodiments and further developments of the invention result from the description, the drawings as well as from the independent claims.

In the following the present invention will be described by way of example with reference to the submitted drawings. There is respectively shown schematically:

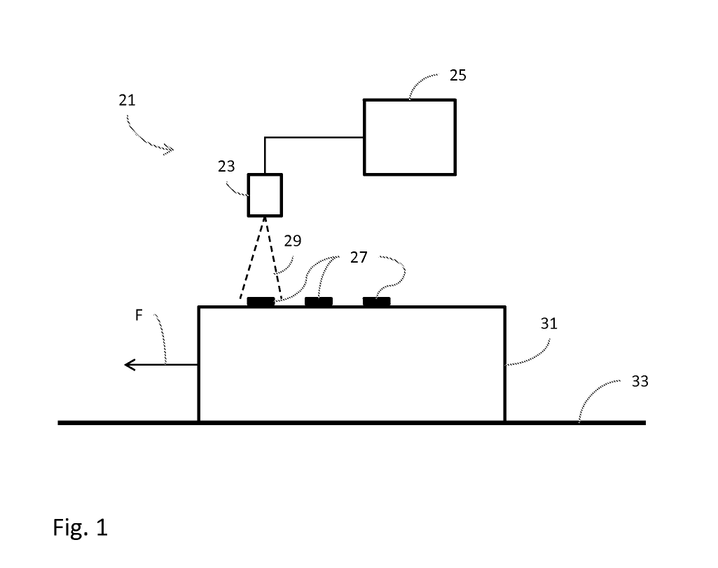

FIG. 1 a side view of a detection system in accordance with the invention;

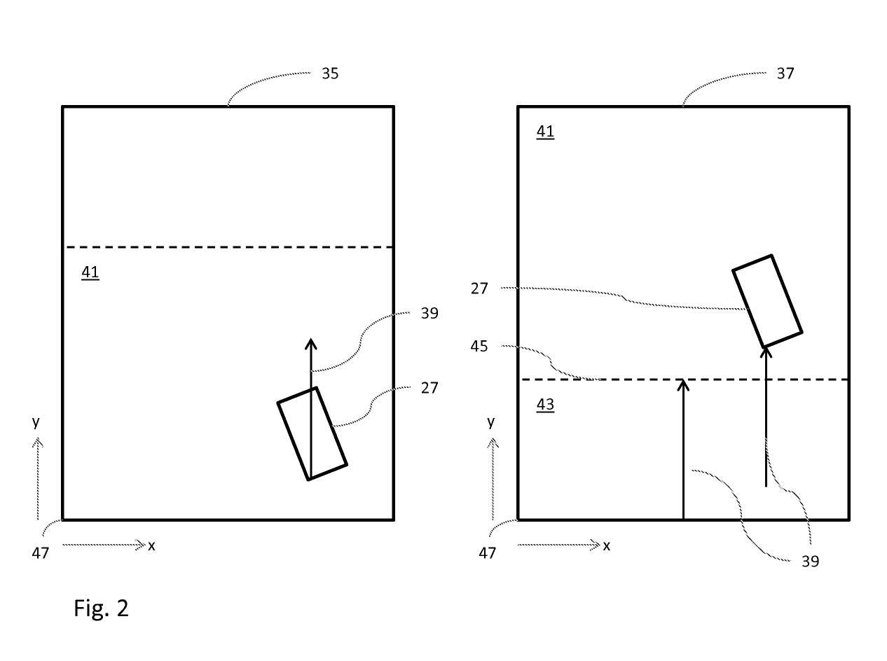

FIG. 2 an i-th image and a consecutive (i+1) image of an image sequence recorded by means of the detection system of FIG. 1;

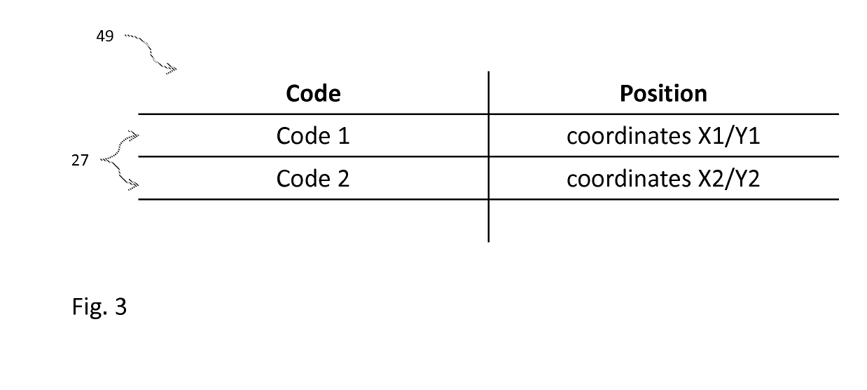

FIG. 3 a tracking list,

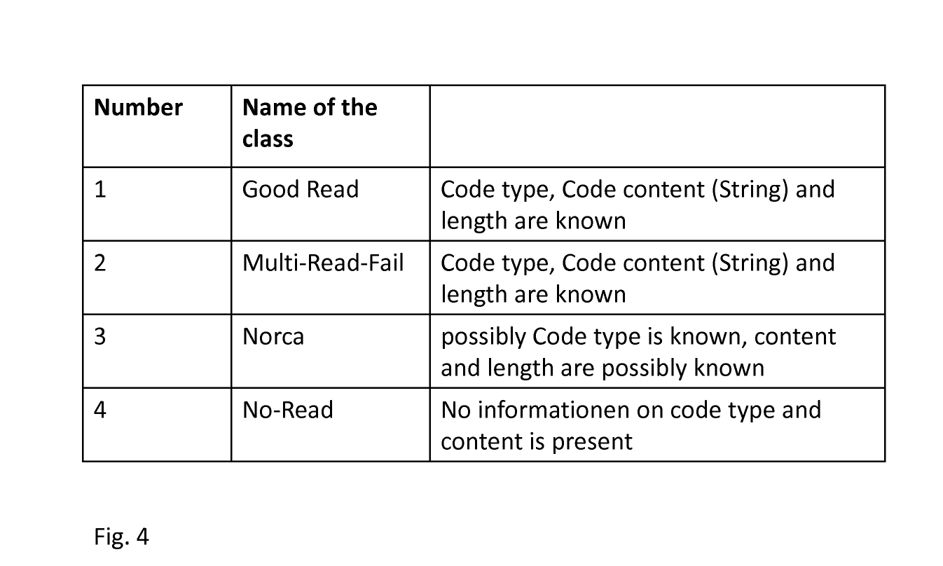

FIG. 4 a table of possible result classes that can be present on the reading of a code; and

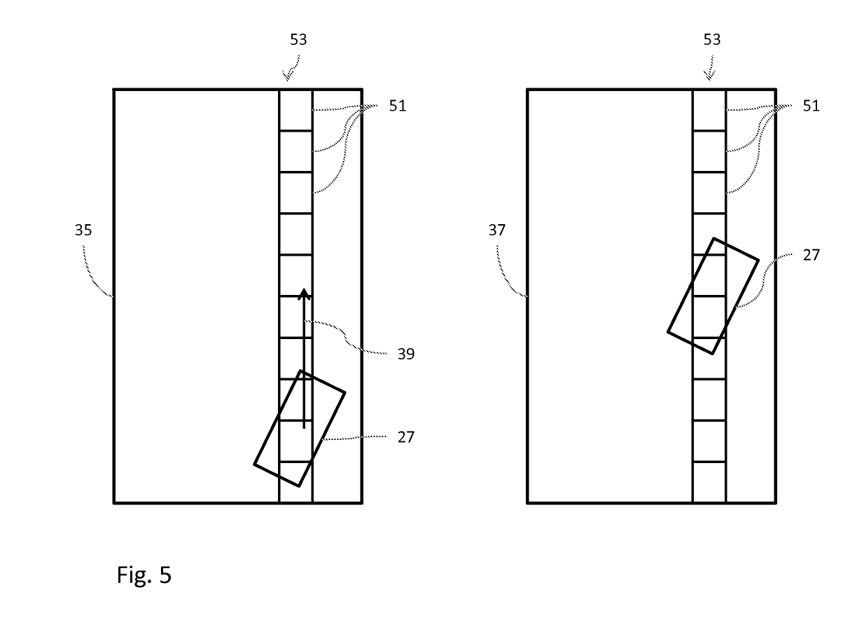

FIG. 5 an i-th images and a consecutive (i+1) image of an image sequence recorded by means of the detection system of FIG. 1 for determining a displacement vector between the two images.

The detection system 21 shown in FIG. 1 has a sensor 23 and an evaluation unit 25 coupled thereto, the evaluation unit 25, for example being able to be formed by a computer. The detection system 21 is configured for the purpose of detecting optical codes 27 that arrive in a reading field 29 of the sensor 23 and/or are transported through the reading field 29. Having regard to the illustrated example, the codes 27 are applied to an object 31 that is conveyed lying on a conveyor belt 33 in a conveying direction F in such a way that the codes 27 pass through the reading field 29.

The conveyor belt 33 can, for example, be a luggage conveyor belt as it is found at airports. The object 31 can, for example, be a suitcase that is conveyed by the conveyor belt 33 from its drop off point, e.g. a check-in counter at an airport, up to its determined point of loading.

By means of the detection system 21, the codes 27 at the objects 31 can be recognized and read out, e.g. in order to control the further transport of the object 31 along the conveyor belt 33 to its determined point of loading. In this respect the sensor 23, that can also be configured as a sensor array, is configured in a manner known per se for the purpose of recognizing and decoding a code 27 present in the reading field 29.

Having regard to the shown example, three codes 27 are arranged at the object 31. Also less than or more than three codes 27 can be provided. For example, also only one code 27 could be applied to the object 31.

The code 27 is, in particular a bar code, a matrix code or any other type of optical code known from the state of the art.

The respective object 31 is normally larger than the reading field 29 of the sensor 23. For this reason a sequence of images of the object 31 is recorded in order to be able to detect and decode all codes 27 at the object 31. More specifically the respective part of the object 31 that is present at the respective recording time of the respective image present in the reading field 29 is recorded in each image. By means of the recorded sequence of images one can achieve a recording of the complete region of the object 31 running through the reading field 29 on a step by step basis and in this way a detection of all codes 27 arranged in the region.

In FIG. 2 the i-th image 35 and the next (i+1) image 37 are illustrated by way of example during the passage of the object 31 through the reading field 29 of the recorded image sequence. As FIG. 2 shows, the code 27 recorded in the (i+1) image 37 is displaced by one displacement vector 39 with respect to the same code 27 recorded in the i-th image 35. The displacement vector 39 can, for example, be related to the pixels included in the images 35, 37. A certain pixel in the image 35 is in this way displaced in the image 37 by the displacement vector 39 in relation to its position in the image 35. The displacement is brought about by the fact that the object 31 is conveyed further by means of the conveyor belt 33 in the conveying direction F by a certain path length in the time span between the recording of the two images 35 and 37.

Generally stated a first image region 41 which is also included in the i-th image is displaced in the (i+1) image due to the conveyance of the object 31 along the conveying direction F by the displacement vector 39. The first image region 41 is also referred to as the recognition region 41 in the following, as this was already recorded in the previous i-th image 35 in relation to the (i+1) image 37.

The second image region 43 recorded in the lower part of the image 37 up to the dotted line (boundary 45) represents a new image region and is subsequently also referred to as a new image region 43. This image region was not recorded in the image 35. The boundary 45 drawn in by way of the dotted line between the recognition region 41 and the new image region 43 then extends displaced by the displacement vector 39 towards the lower image boundary of the image 37.

The detection system 21 and/or its evaluation unit 25 is configured to determine the respective displacement vector 39 which reflects how far a first image region 41 contained in the image 37, that is also present in the previous image 35, is displaced relative to the previous image 35 and indeed on use of the respective consecutive images 35, 37. In this connection the detection system 21 is configured in such a way that it can determine the displacement vector 39 only by means of two consecutive images 35, 37 and, in particular without the use of further sensors other than the sensor 23.

However, prior to explaining how the displacement vector 39 can be determined by way of example in the following (see FIG. 5 and the corresponding description), an explanation will initially be given of how the respective displacement vectors 39 are determined between two consecutive images 35, 37 that can be used for the tracking of the code 27 within the recorded image sequence.

The following and/or tracking of the code 27, in particular means that one can predict the position of the code 27 in the image 37 by means of the position of the code 27 in the image 35 and the displacement vector 39 without the position of the code 27 being determined in the image 37 or before the position of the code 27 is determined in the image 37. The predicted position of the code 27 can in this respect be referred to as the fictitious position of the code 27 in the image 37, as it is a calculated position.

The position of the code 27 in the image 35 can in this respect likewise be calculated as the fictitious position by means of the position of the code 27 in the previous image i−1 and the displacement vector calculated with reference to the previous image i−1 and the i-th image 35 and/or by evaluation of the image 35.

The position of the code 27 in the images 35, 37 can be designated by an X and Y pair of coordinates that, for example state the position of the center or a specific edge of the code 27 in the respective image 35, 37 and which relates to a defined X, Y coordinate system in the respective image 35, 37 whose origin 47, for example, lies in the lower left edge of the respective image 35, 37 and from which the x axis extends to the right and the y axis extends upwardly.

The fictitious position of the code 27 in X, Y coordinates of the coordinate system of the image 37 can in this way be calculated from the position of the code 27 in the image 37, in that the X, Y coordinates of the position of the code 27 are added to the displacement vector 39 in relation to the coordinate system of the image 35.

In this way each one-time detected code 27 can be followed across the recorded sequence of images, this means it can be tracked, in that its fictitious position is newly calculated for each recorded image and indeed with reference to the displacement vector calculated between the previous image and the newly recorded image, wherein the fictitious position is used in relation to the coordinate system of the newly recorded image. Such a tracking of each code 27 detected once can be carried out up to the last image of the image sequence, in such a way that the fictitious position of each code 27 can be calculated with reference to the last image. The relative position of the codes 27 at the object 31 are known by means of the calculated fictitious position of the detected codes 27 in such a way that the codes 27 can be sorted corresponding to their relative position. In this way for example, a stitched complete image of the object 31 can be generated by the evaluation unit 25 and output in which complete image the codes 27 are reproduced in accordance with the relative position with respect to one another.

In accordance with a preferred variant, a tracking list 49 is generated for the following of the codes 27 by the evaluation unit 25, as is illustrated by way of example in FIG. 3 and is stored in a non-illustrated memory of the evaluation unit 25. The sequence of how the codes 27 on the object 31 can be followed and/or tracked with reference to the tracking list 49 will be described in the following.

When the object 31 arrives in the reading field 29 of the sensor 23 a start signal starts the recording of a sequence of images while the object 31 is conveyed through the reading field 23, with the start signal being able to be a so-called “gate on” signal. Moreover, entries possibly present in a tracking list 49 from a previous tracking process are deleted and a “number of codes in the tracking list” recorded in the tracking list 49 is set to zero.

Subsequently a first recorded image i=1 is evaluated with respect to the presence of codes 27. A detected code 27 is decoded. Moreover, the position of the code 27 in the first image i=1 is determined. The decoding result for each code 27 is stored together with its position in the tracking list 49, as shown by way of example and in a simplified manner in FIG. 3 for two codes 27 (code 1, code 2). The position of the respective codes 27 is in this respect stored in the form of X, Y coordinates with respect to the coordinate system of the first image i=1.

Moreover, the “number of codes in the tracking list” recorded in the tracking list 49 is changed in accordance with the number of detected codes 27. In the list 49 a field (not shown in FIG. 3) is moreover included for each code 27, with the field stating whether the code 27 has already been tracked. This so-called field “state of the decoding result” is set to “not tracked” as it is the first image i=1 and in this way no tracking has taken place yet.

Moreover, the displacement vector 39 is set to zero, this means V=(0,0), with the number before the comma relating to a displacement in the X direction and the number after the comma relating to a displacement in the Y direction in accordance with the known description of vectors.

After the second image i=2 has been recorded the displacement vector 39 (cf. FIG. 2) is calculated between the second image i=2 and the first image i=1, as will still be described in the following by way of example. With reference to FIG. 2 the second image i=2 is the (i+1) image 37, whereas the first image i=1 is the i-th image 35.

The second image 37 is divided into the recognition region 41 and the new image region 43 by means of the displacement vector 39. Moreover, the stored position of each detected code 27 is updated by its respective fictitious position in the tracking list 49 in that the displacement vector 39 and the stored coordinates are added in accordance with the rules of vector addition. The fictitious position in this respect reflects the calculated position of the respective code 27 in the second image 37.

In this connection it can occur that the virtual position of a code 27 lies outside of the second image 37 such that the code 27 is no longer present in the second image 37. The field “state of the decoding results” can be set to “finished tracking” for such a code 27 in the list 49, as this code 27 has left the trackable region. However, the respective virtual position of such a code is calculated and updated in the tracking list 49 in relation to the consecutive images.

Moreover, the second image 37 is decoded. In this connection codes 27 are added to the tracking list 49 in the new image region 43—like the codes 27 detected for the first time in the first image 35—and the “number of codes in the tracking list” that are recorded in the tracking list 49 is correspondingly increased. Moreover, the respective field “state of the decoding result” is set to “not-tracked” for these codes 27.

All codes 27 decoded in the recognition region 41 of the second image 37 are compared with the codes 27 already stored in the tracking list 49 and indeed with reference to their coordinates. In this connection all codes 27 detected in the recognition region 41 are investigated with respect to their respective position having regard to a corresponding entry in the tracking list 49, in which the positions of the stored codes 27 are the fictitious positions updated with respect to the second image.

In particular so-called pairs of codes can be identified, wherein a respective code pair is formed from a first code stored in the tracking list 49 and the same, second code decoded in the second image 37. The first code stored in the tracking list 49 and corresponding to the second code detected in the recognition region 41 of the second image 39 can be identified thereby that the position of the second code determined from the second image is compared to the fictitious position of the codes stored in the list 49. In this connection it is assumed that the second code and a first code from the list 49 form a code pair when the fictitious position of the first code and the position of the second code are at least substantially in agreement.

If such a code pair can be identified then this can be compared for the decoding results recorded in the list 49 for the first code with the decoding result obtained by decoding the second code, in particular in order to “calculate” the decoding results with respect to one another. Additionally, the field “state of the decoding result” can be set to “active tracking” for the code.

Prior to explaining in an exemplary manner how the comparison of the decoding result of a code pair can take place, the possible result classes shown by way of a table in FIG. 4 will initially be explained in detail, with the result classes being able to be present on a reading of a code by the sensor 23.

The class having the number 1 relates to the case that a code was successfully decoded. A so-called good read case, with the code type, the code content (string) as well as the code length being able to be determined.

The class having the number 2 relates to the case that a code was indeed successfully decoded, however, could in this respect not be read a plurality of times. This class is referred to as multi read fail class, with the code type, the code content (string), as well as the code length being able to be determined. However, the code security that is expected on a reading of the barcode, was violated.

The class having a number 3 relates to the case that a code could not be decoded with sufficient security, with the code type, the code content and the code length however still being able to be determined eventually. The class with the number 3 is in this respect referred to as a Norca class, where Norca stands for no-read-case analysis.

The class having a number 4 relates to the case that a code could not be successfully decoded. This class is also referred to as a no-read class.

The decoding results of a determined code pair can now be compared to one another and are calculated with respect to one another by means of the followings ways.

Case a: If both the first code and the second code have the result class 1 (good read), then the code content and the symbol type, which correspond to the code type, of both codes can be compared to one another. If the code content and the symbol type for these codes are in agreement then, in particular having regard to barcodes, a multi-read value for the first code recorded in the list 49 is summed and a likewise detecting tracking counter for the first code is increased by one. Moreover, insofar as the sensor 23 and/or the evaluation unit 25 can determine these, so-called verifier values for the verification and feature vectors of the first and the second code are calculated with respect to one another. In this connection e.g. bits in the feature vector can be logically linked with an “or” link.

A feature vector can bitwise code various states of the decoding and/or properties of a decoding region. Examples of such states are: is the code length correct? yes/no. Does a code overlap? yes/no. Is the check sum of a code correct? yes/no. Is a quiet zone violated? yes/no. A feature vector can be composed of 32 bits and in this way include 32 different individual states that result during a segmentation and decoding process in a bit field.

Case b: Do both the first code and/or the second code have the result class 3 (Norca) then possibly no code content is present so that the two codes are only checked with regard to the symbol type. Are the contents in agreement, in particular having regard to barcodes, then the multi-read value for the first code recorded in the list 49 is accumulated and the tracking counter for the first code increased by one. Moreover, insofar as the sensor 23 and/or the evaluation unit 25 can determine these, so-called verifier values and feature vectors of the first and second codes are calculated with respect to one another.

Case c: Does the first code have the result class 3 (Norca) and the second code have the result class 1 (good read) (or vice versa), then the information of the result class 1 write over the information of the result class 3. In particular having regard to barcodes, the multi-read value recorded in the list 49 takes over the corresponding value determined in the result class 1 and the tracking counter is increased by one for the first code. Moreover, insofar as the sensor 23 and/or the evaluation unit 25 can determine these, so-called verifier values and feature vectors of the first and second codes are calculated with respect to one another.

Case d: Having regard to barcodes, if the first code has the result class 2 (multi read fail) and the second code has the result class 2 (multi read fail), then one proceeds as in case a, as a code content is always present also for the result class 2. A check is moreover made at the end, whether a predefined multi-read threshold value for the achieving of the class 1 has been exceeded. If yes, then a change is made from the result class 2 into the result class 1.

Case e: Having regard to barcodes, if the first code has the result class 1 (Good read) and the second code has the result class 2 (multi read fail) or vice versa, then one proceeds like for case a, as a code content is always known.

Case f: Having regard to barcodes, if the first code has the result class 3 (Norca) and the second code has the result class 2 (multi read fail) or vice versa, then the information on the result class 3 is overwritten by the information on the result class 2. In this respect a test with regard to the same symbol type and/or content can be carried out in advance. The result class 3 can possibly be changed into the result class 2 in the tracking list. Moreover, insofar as the sensor 23 and/or the evaluation unit 25 can determine these, so-called verifier values and feature vectors of the first and second codes are calculated with respect to one another.

In the previously described manner the information on all codes 27 recorded in the tracking list 49 which are decoded again in the recognition region 41 of the second image 37 are verified and/or completed.

The procedure described in the foregoing with reference to the second image i=2 is carried out in a corresponding manner for all consecutive images up to the last image of the recorded sequence of images. The recording of the sequence of images is in this respect stopped by a stop signal that is also referred to as a gate-off signal, when it is recognized by the detection system 21 that the object 33 has left the reading field 29.

By means of the previously described procedure the tracking list 49 is gradually assembled in which all codes 27 present at the object 31 and transported through the reading field 29 are included in a decoded form. As, moreover, the respective position of each code 27 is updated by its respective fictitious position from image to image, the respective fictitious position in relation to the last image of the image sequence is finally included for each code 27 in the tracking list 49 in such a way that the relative position of the codes 27 with respect to one another is known.

In this way a virtual stitched image of the object 31 can be generated by means the tracking list 49 which stitched image knows no limitation with regard to the reading field 29 and in which the codes 27 are correspondingly reproduced with regard to their relative position. The evaluation unit 25 can then forward the tracking list 49, or at least an extract thereof, to a subsequent unit, such as an output unit.

The codes 27 included in the recognition region 41 of the (i+1) image 37 are, as described in the foregoing, detected and the decoded under normal circumstances already in the previous i-th image 35 in the tracking list 49. In particular, when a code 27 having a decoding result in accordance with class 1 and 2 shown in FIG. 4 was able to be decoded in the i-th image 35, then it is no longer required to repeat the decoding of the code 27 in the i-th image 35.

In accordance with a modified variant, the fictitious position of the code 27 in the (i+1) image 37 can be determined with reference to the position of a code 27 recorded in the tracking list 49 in the i-th image 35 by means of the displacement vector 39 determined between the i-th image 34 and (i+1) image 37. At the fictitious position and/or in a region about the fictitious position, the code 27 already recorded in the tracking list 49 is located in such a way that this code 27 no longer has to be decoded in the (i+1) image, whereby a corresponding saving in time can be achieved.

A sensor 23 normally works in such a way that a recorded image is initially segmented into regions and the regions including the code therein are subsequently decoded. If it was correspondingly determined in accordance with the previous explanations that an already decoded code 27 lies in a region in the (i+1) image 37, then the corresponding region can be excluded and/or masked out not only from the decoding, but also from the segmentation. Thereby a considerable saving in calculation time for the segmentation and decoding of an image can be achieved for the detection and tracking of the code 27 over and across the sequence of images.

In accordance with a further modified variant the recognition region 41 can be completely masked out for the decoding of the codes 27 in the (i+1) image 37. This means that codes 27 included in the recognition region 41 are generally no longer decoded. Moreover, one can omit a segmentation taking place prior to the decoding of the complete recognition unit 41.

Before explanations are made in detail in the following with reference to FIG. 5, of how a displacement vector 39 is determined between the i-th image 35 and the (i+1) image 37 in accordance with preferred variant, it is explained how the respective displacement vector 39 can be determined between two respective consecutive images 35, 37 in that an optically detectable element is detected in the i-th image 35 and in the (i+1) image 37 and the displacement vector 39 is determined as a displacement between the detected optical elements in the two images.

Having regard to such an optically detectable element it can for example be an edge or a vortex of the object passing through the reading field of the sensor, it can be a marking on the object designed in any possible way, a contour that is provided at the object or on the object or a different element present on the object, that can be detected in the recorded images by the detection system e.g. by means of a blob detection.

The blob detection can e.g. respectively be detected as a focal point of a segmented individual element in the i-th image 35 and in the (i+1) image 37 and the displacement vector 39 can thus be determined between the detected focal points.

Alternatively the same contour can be recognized with a so-called shape locator both in the i-th image 35 as well as in the (i+1) image 37 and the displacement vector 39 can be determined in such a way that it reflects how the contour detected in the (i+1) image 37 is displaced relative to its position and to the previous image 35.

For verification that the same element was actually detected in the consecutive images 35, 37 the areas, the contour or a different property of the element could be determined in both images 35, 37 and can be compared to one another.

In the following it will now be explained with reference to FIG. 5 how a particularly preferred variant of the displacement vector 39 can be determined between the i-th image 35 and (i+1) image 37. In this respect a correlative method is used.

As was previously explained a sensor 23 is configured in a manner known per se for the purpose of initially segmenting a recorded image and to decode the segmented image. Data is obtained for each individual tile 51 of the respective image 35, 37 by means of the segmentation carried out by the sensor 23, with the data, for example, including the respective standard deviation of the colour scale or grey scale in the respective individual tile 51.

That column 53 is determined for the i-th image 35 in which the sum of the standard deviations of the individual tiles 51 is maximum in the column 53. Normally the column 53 having the maximum sum of standard deviations is that column in which at least a large part of a code 27 is present and in this way a comparatively large number of different colour scales or grey scales are present in the column 53. However, the method for determining the displacement vector 39 can also be carried out when no code 27 is present in the images 35, 37, as in fact a column is always present in the i-th image 35 in which the sum of the standard deviations of the colour scales or grey scales is maximum in the individual tiles 51.

Within the column 53 selected in the i-th image 35 a grey scale profile is determined in the centre of the column 53 that can also be under-sampled via the whole image height, this means when viewed in the longitudinal direction of the column 53 and is stored, in particular together with an index characterizing the column 53.

After the recording of the (i+1) image 37, the grey scale profile can likewise be determined in the corresponding column 53 of the image 37 via the image height. Subsequently, the grey scale profile taken from the i-th image 35 is correlated with the grey scale profile taken from the (i+1) image 37. In particular, the lower half of the grey scale profile of the i-th image 35 is correlated with respect to the grey scale profile of the (i+1) image 37. In this respect the lower half of the stored grey scale profile of the i-th image 35 is displaced upwardly with respect to the grey scale profile of the (i+1) image 37 pixel for pixel and for each displacement a correlation coefficient (e.g. in accordance with Pearson) is calculated.

If in this respect xᵢ are n samples of the grey scale profile of the lower half of the i-th image 34 and yᵢ is the corresponding number of n samples of the grey scale profile of the (i+1) image 37, then the correlation coefficient r can be calculated by means of the following equation:

$$r = \frac{{\sum }_{i = 1}^{n} {x}_{i} {y}_{i} - \frac{1}{n} {\sum }_{i = 1}^{n} {x}_{i} {\sum }_{i = 1}^{n} {y}_{i}}{\sqrt{{\sum }_{i = 1}^{n} {x}_{i}^{2} - \frac{1}{n} {( {\sum }_{i = 1}^{n} {x}_{i} )}^{2}} * \sqrt{{\sum }_{i = 1}^{n} {y}_{i}^{2} - \frac{1}{n} {( {\sum }_{i = 1}^{n} {y}_{i} )}^{2}}}$$

The correlation coefficient r obtained for each displacement is stored together with the corresponding displacement u. After the grey scale profile of the lower half of the i-th image 35 has been displaced pixelwise by the maximum possible displacement which corresponds to half of the image height and the corresponding correlation coefficient r was calculated for each displacement the maximum correlation coefficient rₘₐₓ is looked up together with its displacement u from the determined correlation coefficient r.

The same method is carried out with the grey scale profile of the upper half of the i-th image 35 that was displaced downwardly pixel for pixel with respect to the grey scale profile of the (i+1) image 37, wherein, in turn, a respective correlation coefficient r is calculated for each displacement in accordance with the aforementioned equation. From the so determined correlation coefficient r the largest correlation coefficient rₘₐₓ′ is looked up together with its associated displacement u′.

The larger correlation coefficient rₘₐₓ or rₘₐₓ′ of u respectively of u′ now selects the movement direction and in this way selects the displacement vector 39 which corresponds to the displacement u when rₘₐₓ is larger than rₘₐₓ′ and in the other case corresponds to the displacement u′.

Having regard to the assumption of a relatively constant conveying speed the correlation region can be limited following a first time calculation of the displacement vector between the first image i=1 and the second image i=2 for all subsequent image pairs, as for all subsequent image pairs the respective displacement vector at least substantially corresponds to the displacement vector determined between the first and the second image due to the conveying speed as it is assumed to be relatively constant.

In accordance with a variant a parabola fit can be carried out through the discrete maximum rₘₐₓ and/or rₘₐₓ′ and its adjacent points. Thereby the accuracy of the determination of the displacement vector is extended to the subpixel plane.

The displacement vector 39 can thus be saved with regard to the images 35, 37 and, as described in the foregoing, can be used for the tracking of the codes 27.

Furthermore, the conveying speed of the object 31 can be determined without the use of a further sensor by means of the displacement vector 39 and a transformation value for the transformation of the pixels recorded in the images 35, 37 into millimetres, as well as a frame rate of the reading gate 29.

The previously described method for the determination of the displacement vector 39 was described with reference to a normalized grey scale correlation which was carried out in relation to the column 53. This is only to be seen by way of example. Instead of the column 53 also a grey scale correlation can, for example be carried out with respect to a line in the i-th image 35 and the corresponding line in the (i+1) image 37, e.g. with respect to that line in the image 35 whose individual tiles 51 in the sum have the largest standard deviation and/or the largest colour scale or grey scale.

It is particularly advantageous in this connection when individual tile columns are used for the grey value correlation when the codes 27 run through the images 35, 37 from bottom to top or vice versa. In contrast to this it is advantageous when individual tile lines are used for the grey scale correlation, when the codes 27 run through the images 35, 37 from left to right or vice versa. The statement of how the codes 27 run through the images 35, 37 can e.g. be provided by the user of the detection system 21 or be determined itself by the detection system 21.

In accordance with a modified design, the standard deviations of tile lines or of tile columns of two consecutive images 35, 37 can be correlated with respect to one another. Thereby the duration in time that is required for the determination of a respective displacement vector can be shortened. For example, the lower half of the column 53 of the i-th image is displaced upwardly respectively tilewise. Following each displacement a correlation coefficient between the displaced column 53 of the i-th image 35 and the column 53 of the (i+1) image 37 is then calculated on the basis of the standard deviation. In a corresponding manner the upper half of the column 53 of the i-th image 35 is displaced downwardly respectively tilewise and after each displacement a correlation coefficient between the displaced column 53 of the i-th image 35 and the column 53 of the (i+1) image 37 is calculated on the basis of the standard deviation. Thereby, in turn, a maximum correlation coefficient can be determined whose associated displacement corresponds to the displacement vector 39 in the corresponding manner as was already described with reference to FIG. 5 in the foregoing. The accuracy of the determination of the displacement vector 39 in this respect is limited by the resolution of the tiles 51 such that the displacement vector 39 cannot be calculated with pixel accuracy. However, —in the corresponding manner as was previously described—the accuracy of the determination of the displacement vector 39 can be increased thereby that a parabola fit is carried out through the maximum correlation coefficients and its adjacent points.

The previously described method for the determination of the respective displacement vectors between consecutive images can also be integrated into the sensor 23 which is for example configured as an FPGA (field programmable gate array). Thereby the sensor 23 can output the respective displacement vector as additional information for a respective image pair and can, in particular be made available to the evaluation unit 25.

### LIST OF REFERENCE NUMERALS

21 detection system
23 sensor
25 evaluation unit
27 code
29 reading field
31 object
33 conveyor belt
35 i-th image
37 (i+1) image
39 displacement vector
41 first image region, recognition region
43 second image region, new image region
45 boundary
47 origin of the coordinate system
49 tracking list
51 individual tile
53 column
F conveying direction

1. A detection system for optical codes that are applied to an object that is conveyed through a reading field of a sensor of the detection system,
wherein the detection system is configured to record, by means of the sensor, a sequence of images from a respective part of the object which is present in the reading field at the respective time of recording of a respective image each having an image region,
wherein the detection system is further configured to determine a respective displacement vector between two respective consecutive images of the image sequence with reference to the respective two consecutive images, with the respective displacement vector reflecting how far the image region included in an image is displaced relative to the image region included in a previous image.

2. The detection system in accordance with claim 1,
wherein the detection system is configured to determine, by means of the displacement vectors, a respective fictitious position for at least one code detected in the image sequence, at least with respect to the last image of the image sequence.

3. The detection system in accordance with claim 2,
wherein the detection system is configured to sort the detected at least one code in dependence on its/their respective fictitious position with respect to the last image of the image sequence.

4. The detection system in accordance with claim 1,
wherein the detection system is configured to determine a respective fictitious position for all codes detected in the image sequence, at least with respect to the last image of the image sequence, by means of the displacement vectors.

5. The detection system in accordance with claim 4,
wherein the detection system is configured to sort the detected codes in dependence on their respective fictitious position with respect to the last image of the image sequence.

6. The detection system in accordance with claim 1,
wherein the detection system is configured to detect at least the position of the code in the image for a code included in an image.

7. The detection system in accordance with claim 1,
wherein the detection system is configured to decode a code detected in an image.

8. The detection system in accordance with claim 6,
wherein the detection system is configured to store the detected code and/or the position of the code.

9. The detection system in accordance with claim 8,
wherein the detection system is configured to store data of the code obtained by decoding.

10. The detection system in accordance with claim 6,
wherein the detection system is configured to determine a fictitious position of the code with respect to the consecutive image by means of the position of the code in the image and by means of the displacement vector determined between the image and the image consecutive thereto.

11. The detection system in accordance with claim 10,
wherein the detection system is configured to update the position through the fictitious position.

12. The detection system in accordance with claim 10,
wherein the detection system is configured
to determine a further fictitious position of the code with respect to a second consecutive image by means of the fictitious position and by means of the displacement vector determined between the consecutive image and the next, second, consecutive image,
to determine a respective further fictitious position of the code in the respective consecutive image in a corresponding manner for each further consecutive image until the fictitious position of the code is determined with respect to the last image for the last image of the sequence of images.

13. The detection system in accordance with claim 12,
wherein the detection system is configured to store at least the fictitious position of the code with reference to the last image.

14. The detection system in accordance with claim 12,
wherein the detection system is configured to decode a code that is detected at a calculated fictitious position in a respective consecutive image.

15. The detection system in accordance with claim 12,
wherein the detection system is configured to no longer decode the code if the code has already been successfully decoded.

16. The detection system in accordance with claim 12,
wherein the detection system is configured to no longer decode the code if the code has already been successfully decoded in the preceding image.

17. The detection system in accordance with claim 1,
wherein the detection system is configured to identify pairs of codes by means of at least one displacement vector, wherein a respective code pair is formed from a first code and the same second code detected in a later image.

18. The detection system in accordance with claim 1,
wherein the detection system is configured
to compare the position of a second code in a later image with the fictitious position of a first code calculated for the later image; and
to identify the first code and the second code as a code pair when the position and the fictitious position are at least substantially in agreement.

19. The detection system in accordance with claim 17,
wherein the detection system is configured to update and/or to supplement and/or to verify data of the first code obtained by means of decoding with and/or by data of the second code obtained by means of decoding.

20. The detection system in accordance with claim 1,
wherein the detection system is configured to determine a conveying speed with which the object is conveyed through the reading field by means of at least one displacement vector.

21. The detection system in accordance with claim 1,
wherein the detection system is configured to calculate a respective displacement vector between an image and its consecutive image on use of a correlative method in which at least one profile obtained from the image is correlated with a profile obtained from the consecutive image.
